(19) United States
(12) Patent Application Publication
(10) Pub. No.: US 2026/0250108 A1
(43) Pub. Date: Aug. 27, 2026

(54) SYSTEM AND METHODS FOR AUTONOMOUS TRAILER STANDS

(71) Applicant: Robotic Research OpCo, LLC, Clarksburg, MD (US)

(72) Inventors: Steven Rotundo, Baltimore, MD (US); Eric Meyer, Catonsville, MD (US); Alberto Daniel Lacaze, Potomac, MD (US); Karl Nicholas Murphy, Cocoa Beach, FL (US); Greg Ramsey, New Market, MD (US)

(21) Appl. No.: 18/870,581

(22) PCT Filed: May 31, 2023
(86) PCT No.: PCT/US2023/024030

§ 371 Date: Nov. 29, 2024

Related U.S. Application Data
(60) Provisional application No. 63/347,472, filed on May 31, 2022.

(51) Int. Cl. B66F 5/00; B60S 11/00; B66F 7/00

(52) U.S. Cl. CPC B66F 5/00; B60S 11/00; B66F 7/00

(57) ABSTRACT

Systems, apparatus, methods, and articles of manufacture for autonomous trailer stands in which an automatically adjustable trailer stand is placed by an autonomous vehicle, adjusted by the autonomous vehicle to engage with a trailer, and disengaged from (e.g., deposited by) the autonomous vehicle.

### CROSS-REFERENCE TO RELATED APPLICATION(S)

This application claims benefit of and priority under 35 U.S.C. § 119(e) to and is a non-provisional of U.S. Provisional Patent Application No. 63/347,472, filed on May 31, 2022 and entitled “Systems and Methods for Autonomous Trailer Stands,” which is hereby incorporated by reference herein in its entirety.

### FIELD

The present disclosure relates generally to tractor-trailer systems, and more particularly, relates to a semi-autonomous or autonomous hostler or yard vehicle system including a trailer stand for supporting a trailer during loading and unloading of cargo in a trailer yard or warehouse.

### BACKGROUND

A tractor-trailer truck includes a semi-trailer (also referred to herein as “trailer”) releasably coupled to a tractor. At distribution centers, marine terminals, rail heads, yards, warehouses, etc., the trailer is often disconnected from the truck, for example, to enable cargo loading, cargo unloading, storage, or changing between trucks. In these locations, a specialized local yard vehicle (also referred to herein as “hostler,” “hostler truck,” “yard truck,” “yard dog,” “terminal tractor,” “shuttle truck,” or “shunt truck”) may be utilized to couple with and move the trailer to a desired area within the center. Once at the desired area, landing gear mounted to the undercarriage of the trailer is deployed to maintain the trailer in a general level condition relative to the ground.

As trailers are loaded and unloaded in a yard, it is common for forklifts to enter and exit the inside of the trailer. Many accidents occur at this stage. As shown in FIG. 1A and FIG. 1B, for example, a prior art system 100 may comprise a trailer 102 that is at least partially supported by landing gear 102-1 disposed near a first or front end of the trailer. As depicted in FIG. 1A, some accidents may occur if the landing gear 102-1 of the trailer 102 collapses or bends as a forklift 102-2 (e.g., carrying a cargo load 102-3) loads and unloads the cargo 102-3 inside the trailer 102. In some cases, such as depicted in FIG. 1B, a heavy loaded forklift 102-2 advancing beyond the location of the landing gear 102-1 toward the front end of trailer 102 can cause the trailer 102 to upend (e.g., even without the landing gear 102-1 collapsing or failing). All these scenarios are dangerous to the operator of the forklift 102-2 and other personnel surrounding the area. Moreover, a failure of the landing gear 102-1 or upending of the trailer 102 can affect not only the loading dock used by that trailer 102, but it can create a domino effect where other loading docks are affected, and more personnel are at risk.

In order to avoid trailer upending and/or landing gear collapse, many safety conscious yard operators use trailer stands. Trailer stands are devices which are positioned beneath the trailer close to the landing gear or kingpin of the trailer that provide the equivalent of a redundant landing gear. A variety of trailer stands are currently available in the market. They usually include wheels to simplify the process of transport by yard personnel. These trailer stands are installed by a human, in particular, a yard or warehouse operator, who rolls the trailer stand into the yard, sets it up underneath the trailer and adjusts its height to meet the bottom of the trailer. All of these operations are inherently unsafe. The requirement that the operator roll or carry this heavy trailer stand increases the risk of injury (including, tripping and back injury) and also increases the risk of harm to other personnel in the yard along the path of travel. Some yards even recommend using multiple trailers stands for a singular trailer, forcing the operator to perform multiple trips. Further complicating matters is that as the operator installs the trailer stand, the operator is forced to be go beneath the trailer which is extremely dangerous in the event of collapse of the landing gear or upending of the trailer.

Even further, the operator not only has to position these stands beneath the trailer, but also is required to adjust the height of the trailer stand to match the height of the trailer. This increases the amount of time the operator is underneath the trailer and exposed to danger. In addition, the operator has no visibility of activities occurring in the warehouse while other personnel in the warehouse also may be unaware of the location of the operator. Thus, it is entirely feasible that activities associated with movement of cargo may commence before the trailer stand is installed and possibly while the operator is beneath the trailer. The resulting outcome of this occurrence is extremely dangerous to the operator and to the other yard personnel, and also increases the potential for damage to the trailers, cargo etc. These processes are performed multiple times including during installation and removal of the trailer stand.

### SUMMARY

In some embodiments of the present invention, systems and method for autonomous trailer stand deployment alleviate these and other deficiencies of the prior art systems. Some embodiments, for example, provide a system for minimizing human exposure during deployment and collection of the trailer stand. In some embodiments of the invention, the trailer stand is temporarily attached to the end of a yard vehicle or vehicle (e.g., manned and/or autonomous). Yard vehicles or vehicles are used in a yard to dock the trailers to the loading dock. In normal operations, the yard vehicle lifts the trailer from a staging area by connecting its fifth wheel to the trailer, for example, the kingpin of the trailer, moves the trailer to the warehouse, and docks it to the loading dock. The operation at the loading dock lowers the fifth wheel and releases the kingpin.

In some embodiments, a system comprises a vehicle configured to traverse an area, a trailer stand operatively coupled to the vehicle, and configured for positioning relative to a trailer, and one or more controllers for controlling operation of at least one of the vehicle and the trailer stand.

In some embodiments, the trailer stand is positionable beneath the trailer, and is configured to transition between a first condition having a first length and a second condition having a second length greater than the first length.

In some embodiments, an actuator is in communication with the controller for selectively transitioning the trailer stand between the first condition and the second condition.

In some embodiments, the trailer stand is releasably coupled to the vehicle. A coupling mechanism may releasably couple the trailer stand to the vehicle. The coupling mechanism may include at least one of a mechanical coupling, an electrical coupling, an electro-mechanical coupling, a magnetic coupling or an electro-magnetic coupling, or combinations thereof.

In some embodiments, one or more sensors are configured to detect one or more conditions of the trailer stand, and to transmit one or more signals to the controller representative of the one or more conditions. The one or more conditions may include at least one of positional relationship of the trailer stand relative to the trailer, a force exerted by the trailer on the trailer stand, a distance between the trailer stand and the vehicle, presence of the trailer stand and global positional location of the trailer stand.

In some embodiments, the one or more controllers is located on the trailer stand.

In some embodiments, one or more strain sensors are disposed on the trailer stand. The one or more strain sensors include at least one of a lateral strain sensor or a vertical strain sensor.

In some embodiments, the controller is configured to maneuver the vehicle based at least in part on positional data associated with the vehicle truck and the trailer stand.

In some embodiments, an output coupled to the controller provides feedback related to at least one of the trailer stand and the vehicle.

In some embodiments, one or more secondary sensors detect objects within the environment.

The vehicle may be one of a hostler, yard truck and forklift.

In some embodiments, a system comprises a yard vehicle configured to traverse an area, a trailer stand releasably coupled to the yard vehicle, an actuator coupled to the trailer stand to cause transition of the trailer stand between a first transport condition to enable maneuvering of the trailer stand by the yard vehicle about the area and positioning beneath one end of a trailer, and a second deployed condition where the trailer stand supports the one end of the trailer, a controller configured to control the actuator, and one or more sensors to detect a condition of the trailer stand relative to at least one of the yard vehicle and the trailer.

In some embodiments, the controller is configured to control traversing movement of the yard vehicle about the area. One or more secondary sensors may be coupled to at least one of the yard vehicle and the trailer stand. The one or more secondary sensors may be configured to provide one or more signals representative of at least one of a position of the yard vehicle in the area or detection of an object in the area.

In some embodiments, the one or more sensors are configured to detect an orientation of the trailer stand.

In some embodiments, the controller is configured to release the trailer stand from the yard vehicle.

In some embodiments, a system comprises a self-propelled trailer stand configured for movement about a yard, an actuator coupled to the trailer stand to cause transition of the trailer stand between a first transport condition to enable positioning beneath one end of a trailer, and a second deployed condition where the trailer stand supports the one end of the trailer, a controller configured to control movement of the trailer stand about the yard and actuation of the actuator and one or more sensors to detect at least one of an object in the yard, location of the trailer stand or a condition of the trailer stand relative to the trailer.

In some embodiments, a method comprises coupling a trailer stand to a yard vehicle, maneuvering the yard vehicle to a trailer location, positioning, with the yard vehicle, the yard stand beneath a trailer at the trailer location, activating an actuator to deploy the trailer stand to support the trailer and releasing the trailer stand from the yard vehicle. The steps are performed by at least one processor coupled to memory.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1A and FIG. 1B are diagrams of a prior art system;

FIG. 2A, FIG. 2B and FIG. 2C are block diagrams of a system according to some embodiments;

FIG. 3 is a block diagram of a system according to some embodiments;

FIG. 4 is a perspective diagram of a system according to some embodiments;

FIG. 5A, FIG. 5B, FIG. 5C, FIG. 5D, FIG. 5E, FIG. 5F and FIG. 5G are diagrams of a system according to some embodiments;

FIG. 6A and FIG. 6B are diagrams of a system according to some embodiments;

FIG. 7A and FIG. 7B are diagrams of a system according to some embodiments;

FIG. 7C is a block diagram of a system according to some embodiments;

FIG. 8A is a block diagram of an apparatus according to some embodiments;

FIG. 8B is a flow chart of a method of use of the system according to some embodiments; and

FIG. 9A, FIG. 9B, FIG. 9C, FIG. 9D and FIG. 9E are perspective diagrams of exemplary data storage devices according to some embodiments.

### DETAILED DESCRIPTION

### I. Introduction

In the following description of exemplary embodiments, reference is made to the accompanying drawings (where like numbers represent like elements), which form a part hereof, and in which is shown by way of illustration exemplary embodiments in which the invention may be practiced. These embodiments are described in sufficient detail to enable those skilled in the art to practice the invention, but some embodiments may be utilized and logical, mechanical, electrical, and other changes may be made without departing from the scope of the present invention. The following detailed description is, therefore, not to be taken in a limiting sense, and the scope of the present invention is defined by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

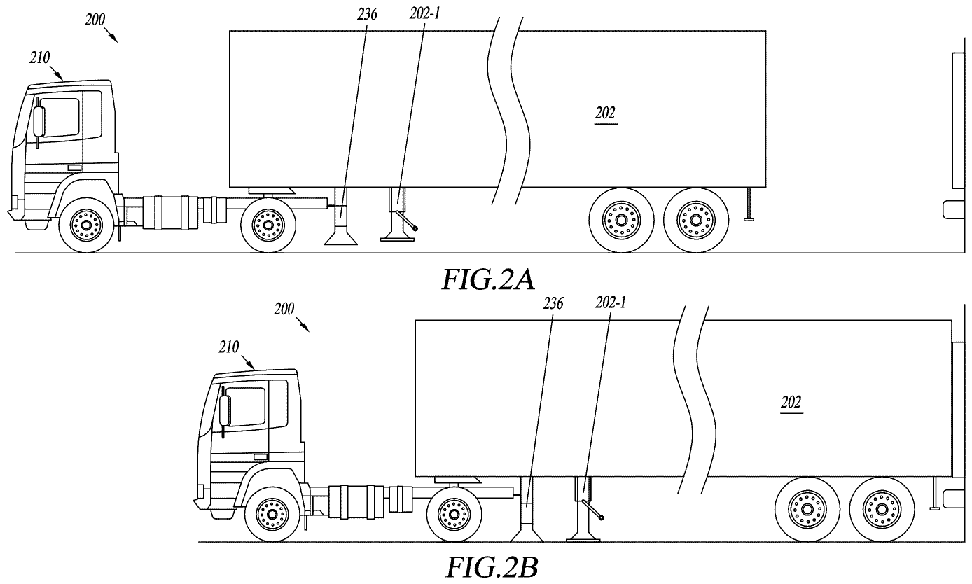

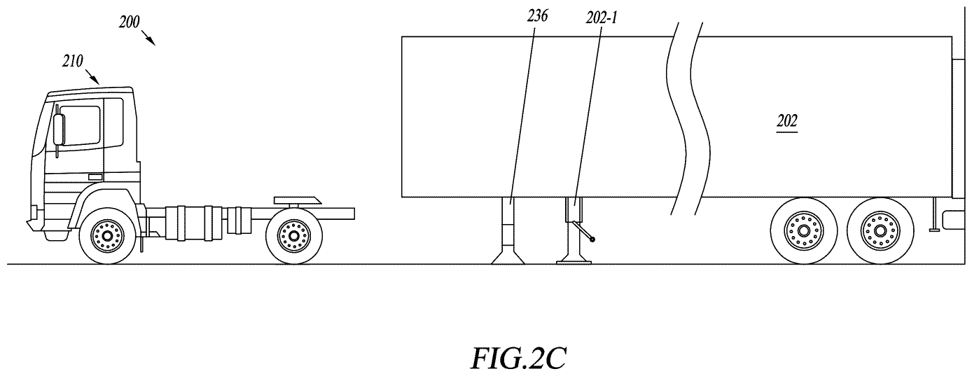

Referring now to FIG. 2A, FIG. 2B and FIG. 2C, block diagrams of a system 200 according to some embodiments are shown. The system 200 may comprise, for example, a trailer 202 which is moved in and out of a yard, warehouse or the like (hereinafter referred to as “environment”). The trailer 202 may be manned, semiautonomous or autonomous. The trailer 202 includes landing gear 202-1 mounted beneath the bed of the trailer 202. The trailer 202 is coupled to (and maneuvered by) a yard hostler/vehicle 210. According to some embodiments, after the yard vehicle 210 is maneuvered within the environment to position the trailer 202 at a location for storage and/or loading or unloading of cargo, the landing gear 202-1 may be deployed. The yard vehicle 210 then releases the trailer 202 (e.g., releases a kingpin thereof; not shown), and may move forward, automatically releasing and/or deploy a trailer stand(s) 236 coupled to, or associated with the yard vehicle 210. In some embodiments, the yard vehicle 210 automatically adjusts the height of the trailer stand(s) 236 to match the height of the trailer 202, leaving the trailer stand(s) 236 protecting the trailer 202 while the cargo is being loaded and unloaded. The trailer stand 236 is independent of the landing gear 202-1. On the reverse operation, once the loading/unloading has been performed, the yard vehicle 210 may backup, automatically meet/couple with the trailer stand(s) 236, automatically lower the height of the trailer stand(s) 236, and/or automatically attach the trailer stand(s) 236 to the rear of the yard vehicle 210. After that process is completed, the yard vehicle 210 may use a fifth wheel coupling 210-1 to latch to the kingpin of the trailer 202 and continue with normal operations in maneuvering, transporting etc. the trailer about the yard or warehouse environment.

Embodiments of the present invention may provide significant advantages over the state of the art. Embodiments may, for example, minimize back injury, tripping hazards, and exposure to weather elements for the trailer stand operator. Embodiments may eliminate the need for the trailer stand operator to be exposed to the danger zone of possible trailer collapse. Embodiments may improve efficiency and minimize manpower by decreasing the number of people walking in the warehouse and/or yard environment. Embodiments may provide a simple and efficient manner to prevent trailer collapses, potentially increasing the usage of these automatically deployed trailer stands and therefore, minimizing warehouse accidents. These and/or additional benefits may be achieved by employing some embodiments.

### II. Autonomous Trailer Stand Systems

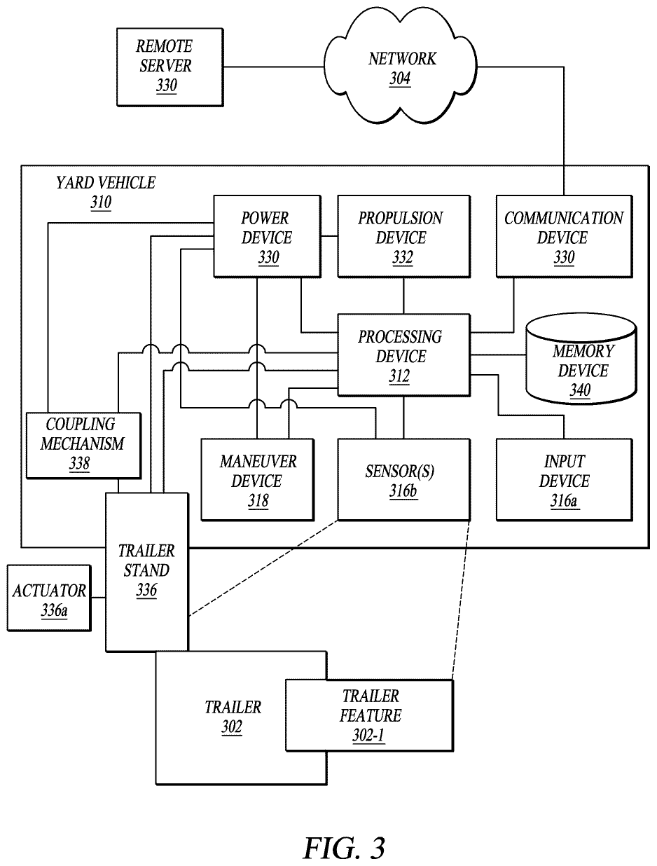

Turning to FIG. 3, a block diagram of a system 300 according to some embodiments is shown. In some embodiments, the system 300 may comprise a trailer 302 (e.g., comprising a trailer feature 302-1), a network 304, and/or a yard vehicle 310. The yard vehicle 310 may comprise, for example, a processing device 312, a communication device 314, an input device 316a, one or more sensors 316b, and/or a maneuver device 318. In some embodiments, the yard vehicle 310 may be in communication with, e.g., via the network 304, a remote server 330. According to some embodiments, the yard vehicle 310 may comprise a propulsion device 332, a power device 334, a trailer stand 336, a coupling mechanism 338 and/or a memory device 340.

Fewer or more components 302, 302-1, 304, 310, 312, 314, 316a-b, 318, 330, 332, 334, 336, 338, 340 and/or various configurations of the depicted components 302, 302-1, 304, 310, 312, 314, 316a-b, 318, 330, 332, 334, 336, 338, 340 may be included in the system 300 without deviating from the scope of embodiments described herein. In some embodiments, the components 302, 302-1, 304, 310, 312, 314, 316a-b, 318, 330, 332, 334, 336, 338, 340 may be similar in configuration and/or functionality to similarly named and/or numbered components as described herein. In some embodiments, the system 300 (and/or portion thereof) may comprise an autonomous trailer stand system and/or platform programmed and/or otherwise configured to execute, conduct, and/or facilitate one or more methods.

According to some embodiments, the trailer 302 may comprise any type, configuration, and/or quantity of trailers that are or become known or practicable. The trailer 302 may comprise, for example, a Great Dane® fifty-three-foot (53′) air-ride dry van trailer with rear swing doors available from Great Dane LLC of Chicago, IL or a Wabash National® tandem high-spec refer trailer available from Wabash National Corporation of Lafayette, IN. In some embodiments, the trailer feature 302-1 may comprise various surfaces, doors, hinges, mounts, hitch points, lights, reflectors, etc. of the trailer 302. In some embodiments, the trailer feature 302-1 may comprise landing gear, a kingpin, a refrigeration (“refer”) unit, etc.

The network 304 may, according to some embodiments, comprise a Local Area Network (LAN; wireless and/or wired), cellular telephone, Bluetooth®, Near Field Communication (NFC), and/or Radio Frequency (RF) network with communication links between the remote server 330 and the yard vehicle 310. In some embodiments, the network 304 may comprise direct communication links between any or all of the components 302, 302-1, 310, 312, 314, 316a-b, 318, 330, 332, 334, 336, 338, 340 of the system 300. The sensor 316b may, for example, be directly interfaced or connected to one or more of the processing device 312 and/or the remote server 330 via one or more wires, cables, wireless links, and/or other network components, such network components (e.g., communication links) comprising portions of the network 304. In some embodiments, the network 304 may comprise one or many other links or network components other than those depicted in FIG. 3. The yard vehicle 310 may, for example, be connected to the remote server 330 via various cell towers, routers, repeaters, ports, switches, and/or other network components that comprise the Internet and/or a cellular telephone (and/or Public Switched Telephone Network (PSTN)) network, and which comprise portions of the network 304.

While the network 304 is depicted in FIG. 3 as a single object, the network 304 may comprise any number, type, and/or configuration of networks that is or becomes known or practicable. According to some embodiments, the network 304 may comprise a conglomeration of different sub-networks and/or network components interconnected, directly or indirectly, by the components 302, 302-1, 310, 312, 314, 316a-b, 318, 330, 332, 334, 336, 338, 340 of the system 300. The network 304 may comprise one or more cellular telephone networks with communication links between the communication device 314 and the remote server 330, for example, and/or may comprise an NFC or other short-range wireless communication path, with communication links between the yard vehicle 310 and the trailer feature 302-1, for example.

According to some embodiments, the yard vehicle or hostler 310 may comprise any type, configuration, and/or quantity of vehicle, manned, unmanned, autonomous, or semi-autonomous, that is or becomes known or practicable. The yard vehicle 310 may comprise, for example, an autonomous path-following transportation vehicle that is operable to follow one or more predefined and/or automatically computed paths through a yard (not shown) or a manned yard vehicle 310 including one or more sensors 316b that facilitate safe traversal of the manned yard vehicle 310 through the yard. In some embodiments, the yard vehicle 310 may comprise the processing device 312 such as a Central Processing Unit (CPU) that executes instructions (not shown) stored in the memory device 340 to operate in accordance with embodiments described herein. The processing device 312 may, for example, execute one or more programs, modules, and/or routines that facilitate utilization of the sensor 316b and/or the communication device 314 to facilitate safe maneuvering of the yard vehicle 310 through the yard, e.g., as it transports, parks, and/or retrieves the trailer 302. The processing device 312 may comprise, in some embodiments, one or more Eight-Core Intel® Xeon® 7500 Series electronic processing devices.

According to some embodiments, the communication device 314 may comprise any wired and/or wireless communication object and/or network device such as, but not limited to, a Radio Frequency (RF) antenna, transmitter, and/or receiver. In some embodiments, the communication device 314 may comprise hardware, software, and/or firmware operable to enable wireless communications including, but not limited to, encoding and/or decoding modules, filters, and/or encryption and/or decryption modules. In some embodiments, the communication device 314 may comprise one or more output devices such as buzzers, lights, alarms, vibration devices, etc. The communication device 314 may comprise, for example, an Advanced Driver Assistance Systems (ADAS) output device that provides ADAS output to a driver of the yard vehicle 310.

According to some embodiments, the input device 316a may comprise one or more of a throttle, a steering, and a brake control mechanism and/or interface via which a human operator may control the speed and/or direction of the yard vehicle 310. The operator may, for example, utilize the input device 316a to define a control action to decide the speed of the yard vehicle 310 as well as to make decisions such as when to stop or to continue past, around, over, and/or under (e.g., to mate with or to clear/avoid) the trailer feature 302-1. According to some embodiments, the input device 316a may comprise one or more switches, levers, wheels, pedals, and/or interface elements capable of communicating speed, direction, etc.

In some embodiments, the input device 316a may comprise any type, quantity, and/or configuration of location identification and/or tracking device that is or becomes known or practicable. The input device 316a may comprise a location device, for example, such as one or more Global Positioning System (GPS) devices, wireless signal triangulation devices, atomic clocks, etc.

According to some embodiments, the one or more sensors 316b may comprise any type, configuration, and/or quantity of sensor devices that are or become known or practicable. In some embodiments, the one or more sensors 316b may comprise a Light Detection and Ranging (LiDAR), LAser Detection and Ranging (LADAR), radar, sonar, Infrared Radiation (IR), RF, ultrasound, structured light, and/or imaging (e.g., stereo vision and/or 3-D camera) device operable to acquire data descriptive of the trailer 302 and/or the trailer feature 302-1 (e.g., hitch points) thereof. According to some embodiments, the one or more sensors 316b may also or alternatively comprise a gyroscope, image, audio, and/or video capture and/or recording device, chemical detection device, and/or a light sensor. According to some embodiments, the one or more sensors 316b may comprise various movement sensors such as speed/velocity sensors, pressure sensors, temperature sensors, accelerometers, Inertial Measurement Unit (IMU) devices, and/or tilt sensors. In some embodiments, the sensor 316b may be a navigation sensor used to determine relative or absolute position of the yard vehicle 310 and/or the trailer stand 336. For example, the navigation sensor can comprise one or more global navigation satellite (GNSS) sensor, such as a global positioning system (GPS) sensor or device. In some embodiments, the one or more sensors 316b may comprise one or more sensors defining an ADAS that operates to warn and/or guide the operator and/or yard vehicle 310 through the yard. The sensor 316b may comprise, for example, one or more of:
(i) Trailer Centering—as the operator backs up the trailer, proper alignment with the dock and the parking lines is important. This ADAS provides a variety of feedback: it provides separation distances to the adjacent trailers, it provides distances to the right and left line markers, it provides centering to the dock, it provides distance from the dock;
(ii) Tilted Trailer Detection—when a trailer is not fully vertical, it is a possible indication of uneven load distribution indicative of cargo collapse inside of the trailer or possibly a flat tire or structurally unstable trailer. This ADAS will measure the walls of the trailer for verticality and measure the formation of these walls as the trailer is moved around by the yard truck;
(iii) Trailer Rotation Point Detection—most trailers have two or three axels. The location and separation of these axels vary from trailer to trailer. Moreover, the load carried by each axle can vary depending on adjustments and general wear and tear of the suspension and even depending on tire inflation and wear. It is difficult for a human to determine the location of the center of rotation around the rear axles. This ADAS system can measure an approximate center of rotation more accurately than a human. Changes to the center of rotation, affect the kinematics of the overhang and to a certain degree, the kinematics of the path being followed. This is more evident when backing up and when the tractor and trailer are closer to orthogonal positions. This ADAS will help the driver determine the center of rotation and automatically feed other ADAS like the overhang collision detection. Or possibly detect trailer malfunction;
(iv) Fifth Wheel-Kingpin Mating Aid—as the yard truck backs up to mate the fifth wheel and kingpin, the driver has approximately +/−6 inches error budget. This ADAS provides the drive left and right adjustments to more accurately get the fifth wheel within the error budget. This ADAS also provides a measurement that indicates the distance to the kingpin;
(v) Trailer Stand Detection—Sometimes, trailer stands are used in the yard to minimize the likelihood of trailer upending or landing gear collapse. This ADAS will help detect a trailer stand usually installed under the trailer and therefore stop the driver from trying to mate. Because the trailer stands are under the trailer this requires a different type of obstacle detection that what is used on other areas; and/or
(vi) Distance to dock Aid. This aid provides a measurement from the dock to the trailer. In other words and indication on how much it should back up before the trailer bumps the dock. This is computed by sensing the length of the trailer and sensing the distance to the dock.

In some embodiments, the maneuver device 318 may comprise any type, quantity, and/or configuration of mechanical, electrical, and/or electro-mechanical devices that are operable to control the path of the yard vehicle 310. The maneuver device 318 may comprise, for example, steering linkage, actuators, control surfaces, thrust vectoring devices, etc. In some embodiments, the maneuver device 318 may be coupled to and/or in communication with the propulsion device 332. The maneuver device 318 may comprise, for example, a steer-by-wire system that permits computerized control of the maneuvering of the yard vehicle 310. The maneuver device 318 and the propulsion device 332 may, for example, operate in a coordinated fashion (e.g., in response to commands from the processing deice 312) to cause the yard vehicle 310 to follow a desired path and/or route through the yard.

According to some embodiments, the propulsion device 332 may comprise any type, configuration, and/or quantity of propulsion devices that are operable to move the yard vehicle 310 from one location to another. The propulsion device 332 may comprise, for example, one or more motors, engines, gears, drives, propellers, fans, jets, nozzles, wheels, treads, and/or magnetic propulsion devices. According to some embodiments, the power device 334 may be electrically coupled to provide power to any or all of the propulsion device(s) 332, the communication device 314, the processing device 312, the input device 316a, the one or more sensors 316b, and/or the maneuver device 318. In some embodiments, the power device 334 may comprise a power source such as a solar panel, inertial generator, on-board generator, alternator, fuel-cell, external power supply port, etc. According to some embodiments, the power device 334 may also or alternatively comprise a power storage device such as one or more capacitors, batteries, fuel reservoirs or tanks, etc.

In some embodiments, the yard vehicle 310 may comprise and/or be coupled to the trailer stand 336. The trailer stand 336 may comprise, for example, an automatically extendible and/or adjustable stand, lift, strut, and/or jack that may be automatically placed and/or retrieved by the yard vehicle 310. The trailer stand 336 may be automatically placed by the yard vehicle 310, for example, automatically adjusted to extend between a ground surface (not shown) and the trailer 302 (and/or the trailer feature 302-1 thereof), automatically adjusted to retract from the full distance between the ground surface and the trailer 302, and/or be automatically retrieved by the yard vehicle 310. According to some embodiments, the trailer stand 336 may be associated with or comprise actuator components 336a that perform and/or facilitate height adjustment of the trailer stand 336 and/or positioning such as hydraulic and/or pneumatic pistons, gears, belts, pulleys, ratchets, dampers, motors, compressors, processing units, and/or communication devices. The actuator components 336a may be controlled by the processing device 312 and the power device 312 associated with the yard vehicle 310.

In some embodiments, the yard vehicle 310 may optionally include a coupling mechanism 338 adapted for releasably coupling the trailer stand 336. The coupling mechanism 338 may be any mechanical, electrical, electro-mechanical or elector-magnetic system configured to selectively couple to the trailer stand 302 to move the trailer stand 302 about the yard or relative to the trailer 302 and selectively release the trailer stand 302 to enable deployment beneath the trailer 302. The coupling mechanism 338 may include components on each of the yard vehicle 310 and the trailer stand 336.

In some embodiments, the memory device 340 may store various logic, code, and/or applications, each of which may, when executed, participate in, facilitate, and/or cause yard vehicle 310 and/or automatic trailer stand 336 operation, as described herein. In some embodiments, the memory device 340 may comprise any type, configuration, and/or quantity of data storage devices that are or become known or practicable. The memory device 340 may, for example, comprise an array of optical and/or solid-state memory cards or hard drives configured to store sensor data, maneuvering data, object classification data, navigation data, road network data, rules of the road data, routing data (e.g., analysis formulas and/or mathematical models), credentialing and/or communication instructions, codes, and/or keys, and/or various operating instructions, drivers, etc. In some embodiments, the memory device 340 may comprise a solid-state and/or non-volatile memory card (e.g., a Secure Digital (SD) card, such as an SD Standard-Capacity (SDSC), an SD High-Capacity (SDHC), and/or an SD eXtended-Capacity (SDXC) and any various practicable form-factors, such as original, mini, and micro sizes, such as are available from Western Digital Corporation of San Jose, CA. While the memory device 340 is depicted as a stand-alone component of the yard vehicle 310, the memory device 340 may comprise multiple components. In some embodiments, a multi-component memory device 340 may be distributed across various devices and/or may comprise remotely dispersed components. Any of the yard vehicle 310, the trailer stand 336, and/or the remote server 330 may comprise the memory device 340 or a portion thereof, for example. In addition, any of the components of the system may be included in the yard vehicle 310, the trailer stand 336 or a combination thereof.

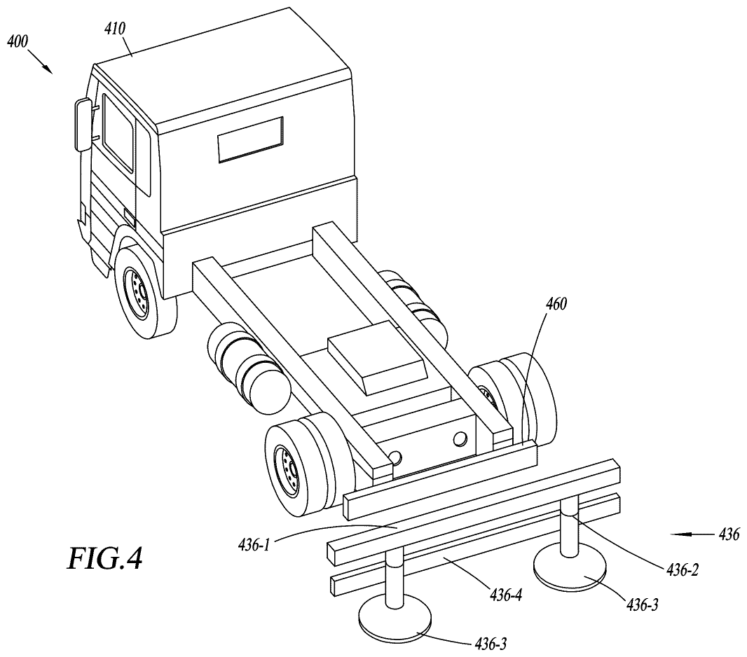

Referring now to FIG. 4, a perspective diagram of a system 400 according to some embodiments is shown. In some embodiments, the system 400 may comprise a yard vehicle 410 that selectively and/or automatically couples to, controls, and/or couples/uncouples a trailer stand 436. In the non-limiting exemplary configuration shown in FIG. 4, the trailer stand 436 may comprise a bearing portion or head 436-1 coupled to a plurality of supporting legs 436-2 that rest upon (and/or are coupled to) corresponding feet 436-3. In some embodiments, the bearing head 436-1 may be an elongated rectangular element having a cross-sectional area sufficient to engage a lower surface of a trailer and stabilize the trailer. However, other configurations for bearing head 436-1 are envisioned. According to some embodiments, the trailer stand 436 may be selectively and/or automatically raised and/or lowered such as by extension or contraction through an actuator component (336a in FIG. 3; not shown in FIG. 4) associated with or coupled to the supporting legs 436-2. The supporting legs 436-2 may be telescoping and/or otherwise adjusted to various lengths, for example, such that a height of the head 436-1 may be set to a desired level (e.g., altitude and/or distance from a datum such as a ground surface). The feet 436-3 may be, in some embodiments, circular, or optionally may be any configuration. The feet 436-3 are sufficiently wide to stabilize the trailer stand 436 and support the trailer, cargo within the trailer and/or a forklift traversing the inside of the trailer.

In some embodiments, the trailer stand 436 may comprise a mating element 436-4 (schematically depicted) that is configured to mate with a corresponding mount 460 (also schematically depicted) of the coupling mechanism of the yard vehicle 410. The mating element 436-4 and the mount 460 may be components of one or more coupling mechanisms configured to releasably couple the trailer stand 436 to the yard vehicle 410. In some embodiments, the yard vehicle 410 may couple to the trailer stand 436, for example, by mechanically and/or electrically connecting mechanisms. (See, e.g., coupling mechanism 338 of FIG. 3) The mount 460 may comprise, for example, one or more mechanical, electrical, and/or magnetic coupling and/or communication features (not separately shown) such as detents, protrusions, sockets, lips, flanges, arms, teeth, jaws, connectors, ports, and/or other interfaces that enable the yard vehicle 410 to transport the trailer stand 436 from one place to another (e.g., raised off of the ground), place the trailer stand 436 at a desired location, decouple from/deposit the trailer stand 436 at the desired location, actuate the supporting legs 436-2 of the trailer stand 436, for example, through the actuation mechanism 336a (FIG. 3) to raise the head 436-1 of the trailer stand 436 to engage with a trailer (not shown in FIG. 4), receive data from the trailer stand 436 (e.g., sensor data), navigate to the trailer stand 436, couple with and/or pick-up the trailer stand 436, and/or actuate the supporting legs 436-3 of the trailer stand 436 to lower the head 436-1 of the trailer stand 436 to disengage with the trailer.

Fewer or more components 410, 436, 436-1, 436-2, 436-3, 436-4, 460 and/or various configurations of the depicted components 410, 436, 436-1, 436-2, 436-3, 436-4, 460 may be included in the system 400 without deviating from the scope of embodiments described herein. In some embodiments, the components 410, 436, 436-1, 436-2, 436-3, 436-4, 460 may be similar in configuration and/or functionality to similarly named and/or numbered components as described herein. In some embodiments, the system 400 (and/or portion thereof) may comprise an autonomous trailer stand system and/or platform programmed and/or otherwise configured to execute, conduct, and/or facilitate one or more methods.

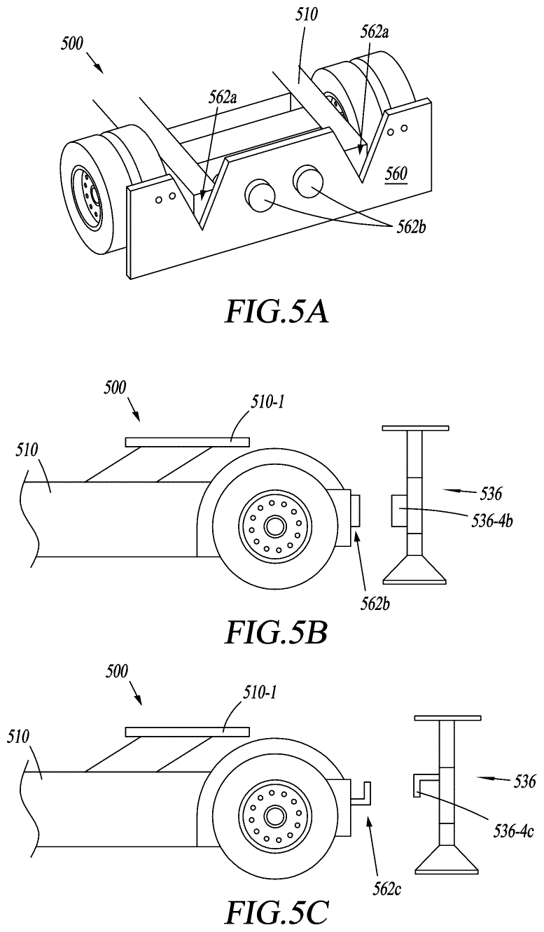

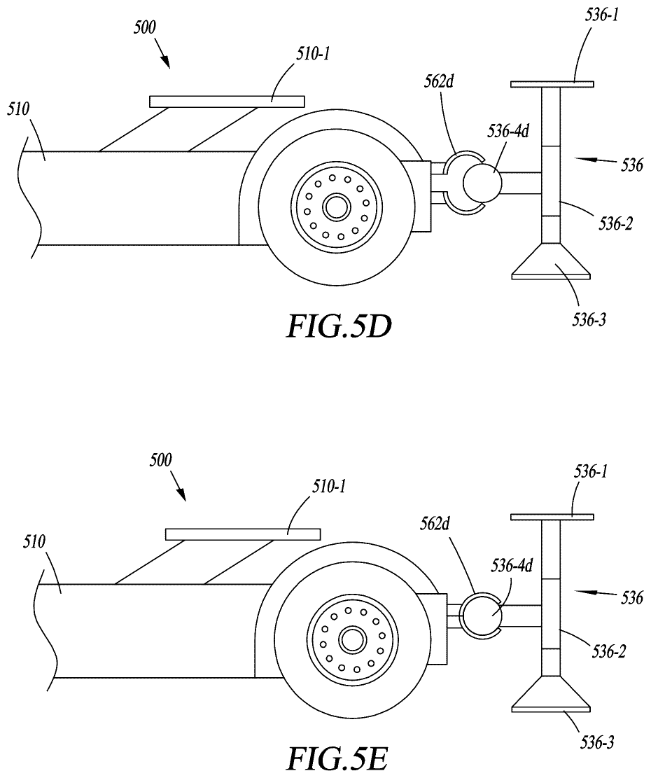

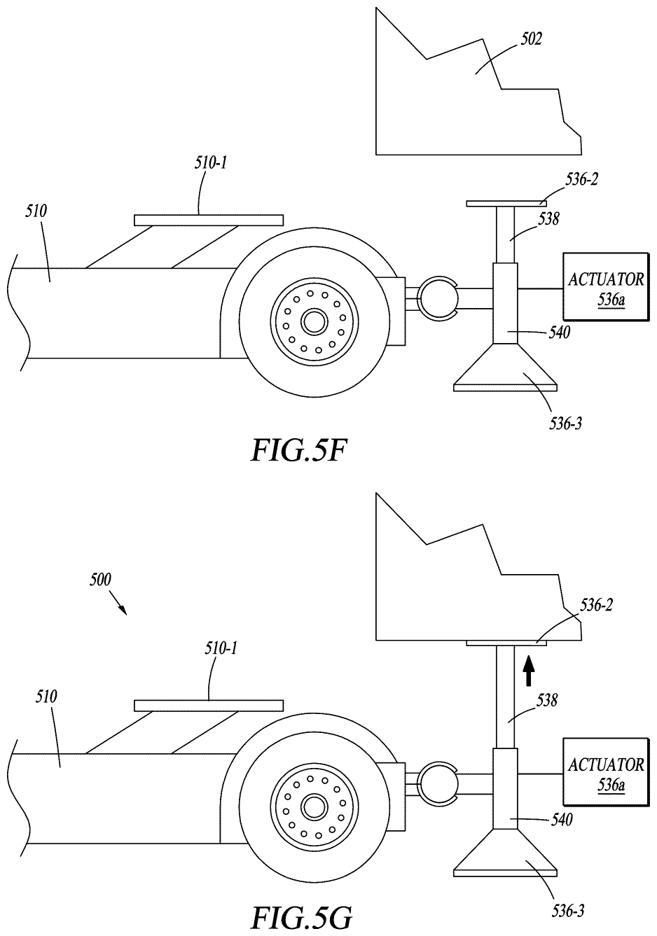

Turning now to FIG. 5A, FIG. 5B, and FIG. 5C, diagrams of a system 500 according to some embodiments are shown. In some embodiments, the system 500 may comprise a yard vehicle 510 comprising a fifth-wheel coupling 510-1. According to some embodiments, the system 500 may comprise an autonomous trailer stand 536 comprising one or more coupling mechanisms 536-4b, 536-4c that selectively and/or automatically couple to a corresponding mount 560 of the yard vehicle 510.

Yard vehicles/yard vehicles 510 that maneuver when docking a trailer (not shown) to a loading dock (also not shown), already need to be precise. The spaces between the trailers and the loading dock do not leave room for error. This can be utilized as an advantage in some embodiments that simplifies the mating and un-mating mechanism (e.g., the mount 560) between the yard vehicle 510 and the trailer stand 536. The fifth wheel attachment 510-1, when mating with a kingpin (not shown) of a trailer, provides approximately six inches (6″) sideways error budget. Therefore, it may be convenient in some embodiments to provide an error budget that matches that of the kingpin-fifth wheel attachment. In some embodiments this may be accomplished mechanically by providing funnel like guiderails or first mechanical mating features 562a similar to the engagement between the fifth wheel 510-1 and kingpin. Other geometrical configurations are also possible.

The coupling and holding of the trailer stand(s) 536 to the yard vehicle 510 can be accomplished in various manners such as, but not limited to, utilizing electromagnet connectors or second mating features 562b of the yard vehicle 510 which mate with corresponding electromagnet connectors or second mating features 536-4b of the trailer stand 536 to releasably couple the trailer stand 536 to the yard vehicle 510. In some embodiments, the yard vehicle 510 may include one or more mechanical hooks or third mating features 562c that engage correspondingly dimensioned hooks or third mating structures 536-4c of the trailer stand(s) 536 to releasably couple the trailer stand 536 to the yard vehicle 510. In some embodiments, the mating structure of the yard vehicle 510 may include mount 560 and any of the aforedescribed mating structures of the trailer stand 536.

Fewer or more components 510, 536, 536-4b, 536-4c, 560, and 562a-c and/or various configurations of the depicted components 510, 536, 536-4b, 536-4c, 560, and 562a-c may be included in the system 500 without deviating from the scope of embodiments described herein. In some embodiments, the components 510, 536, 536-4b, 536-4c, 560, and 562a-c may be similar in configuration and/or functionality to similarly named and/or numbered components as described herein. In some embodiments, the system 500 (and/or portion thereof) may comprise an autonomous trailer stand system and/or platform programmed and/or otherwise configured to execute, conduct, and/or facilitate one or more methods.

FIGS. 5D and 5E illustrate a releasable coupling mechanism which, in some embodiments, includes a split c-shape clamp 562d on the yard vehicle 510 and a mounting ball 536-4d coupled or integrally formed with the trailer stand 536. The split c-shape clamp 562 includes opposing components which move toward and away from each other in response to instructions provided to the coupling mechanism 338 via the processing device 312 (FIG. 3). In the open condition, the c-shape clamp 562d may receive the mounting ball 536-4d. In the closed condition, the c-shape clamp 562d securely clamps the mounting ball 536-4d to couple the trailer stand 536 to the yard vehicle 510 enabling transfer of the coupled trailer stand 536 about the yard or warehouse via the vehicle trailer 510 In some embodiments, as depicted in FIGS. 5F and 5G, coupling of the c-shape clamp 562 and the mounting ball 536-4d may also couple, e.g., electrically couple, the actuator 536a (shown schematically) of the trailer stand 536. (See also, e.g., actuator 336a and processor 336 of FIG. 3). In the coupled condition, the processor may control the actuator 536a to cause transition of the trailer stand 536 between a non-deployed condition (FIG. 5F) and a deployed condition (FIG. 5G). More specifically, the actuator 536a controlled via, for example, the processor 312 (FIG. 3) may cause telescoping component 538 of the trailer stand 536 to reciprocate within base sleeve 540 of the trailer stand 536. Various mechanisms to cause movement of the telescoping component include, without limitation, a lead screw worm gear, a ratcheting arm, and/or a hydraulic and/or pneumatic drum, controlled via the processor. FIG. 5G illustrate the trailer stand 536 engaging the trailer 502 in supporting relation therewith. In some embodiments, the trailer stand 536 may lift the trailer 502 to various vertical positions. In some embodiments, the trailer stand 536 may be disposed at the extreme front end or nose of the trailer 501 in engagement, for example, with a support member traversing the bottom of the trailer 502.

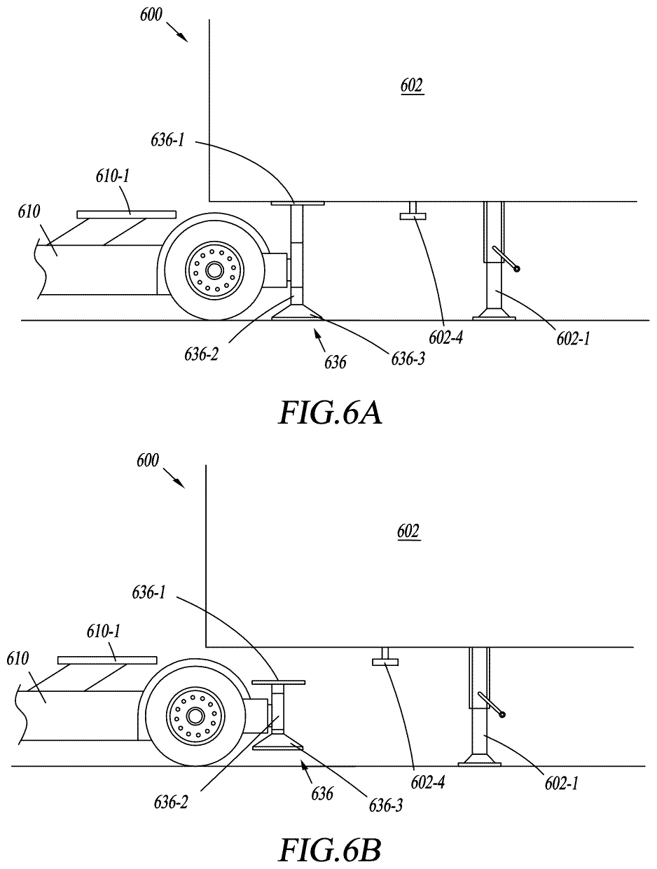

Turning now to FIG. 6A and FIG. 6B, diagrams of a system 600 according to some embodiments are shown. The system 600 may comprise, for example, a trailer 602 comprising landing gear 602-1 and a kingpin 602-4. According to some embodiments, a yard vehicle 610 may comprise a fifth wheel coupling 610-1 and/or may selectively carry, place, and/or retrieve a trailer stand 636 that supports an overhang portion of the trailer 602 distal from the landing gear 602-1 at a first end of the trailer 602 (e.g., the only end partially depicted in FIG. 6A and FIG. 6B).

Same as with conventional trailer stand(s), the trailer stand(s) 636 may provide sufficient loading capacity to stop the trailer 602 from collapsing. The trailer stand 636 may also or alternatively provide some side loading capabilities as to counteract the forces generated by the acceleration and deceleration of a forklift (not shown) inside of the trailer 602. According to some embodiments, the trailer stand 636 may thus comprise three (3) main components: (i) a landing head 636-1 that will be in contact with the trailer 602 (e.g., when in a deployed state) (FIG. 6A), (ii) feet 636-3 that have sufficiently wide stance to tolerate side loading, and/or (iii) an expandable body 636-2 that can adjust its length to wedge the trailer stand 636 between the ground and the bottom of the trailer 602 through, for example, an actuator (actuator 336a of FIG. 3). The trailer stand 636 may include components of a coupling mechanism (not shown) to facilitate coupling with the yard vehicle 610.

In some embodiments, the expandable body 636-2 of the trailer stand 636 may utilize an actuator and/or similar mechanisms as the ones used in traditional jacks. This could be a lead screw worm gear, a ratcheting arm, and/or a hydraulic and/or pneumatic drum. According to some embodiments, as the trailer stand 636 will be carried by the yard vehicle 610, it may be convenient if the attachment mechanism (not shown) stays level and aligned with the corresponding attachment point (not separately shown) on the back of the yard vehicle 610 (e.g., if an electromagnet is used). For example, in some embodiments, two lead screws (not shown) may be used that expand the trailer stand 636 (e.g., the expandable body 636-2 portion) both up and down as to maintain the attachment on the back of the yard vehicle at the same height.

According to some embodiments, the trailer stand 636 may be limited to expanding above or below the attachment point of the yard vehicle 610, however, there may be a mechanism on the back of the yard vehicle 610 that can raise the trailer stand 636 from the ground, so it is not dragged while the yard vehicle 610 is moving around. In some embodiments, the trailer stand 636 may comprise a battery and remote controller (neither of which is shown) that performs the expanding/contracting action. According to some embodiments, the trailer stand 636 does not have its own energy storage. Instead, the yard vehicle 610 provides electrical and/or mechanical power through the coupling mechanism. (e.g., coupling mechanism 338 of FIG. 3). In some embodiments, the trailer stand 636 may only be contracted or expanded while still attached to the back of the yard vehicle 610. In some embodiments, the trailer stand 636 can be deployed while the fifth wheel coupling 610-1 is still attached to the kingpin 602-4. In some embodiments, the trailer stand 636 utilizes the fifth wheel attachment 610-1 and it attaches to the kingpin 602-4 to the trailer itself.

Fewer or more components 602, 602-1, 602-4, 610, 610-1, 636, 636-1, 636-2, 636-3 and/or various configurations of the depicted components 602, 602-1, 602-4, 610, 610-1, 636, 636-1, 636-2, 636-3 may be included in the system 600 without deviating from the scope of embodiments described herein. In some embodiments, the components 602, 602-1, 602-4, 610, 610-1, 636, 636-1, 636-2, 636-3 may be similar in configuration and/or functionality to similarly named and/or numbered components as described herein. In some embodiments, the system 600 (and/or portion thereof) may comprise an autonomous trailer stand system and/or platform programmed and/or otherwise configured to execute, conduct, and/or facilitate one or more methods of some embodiments.

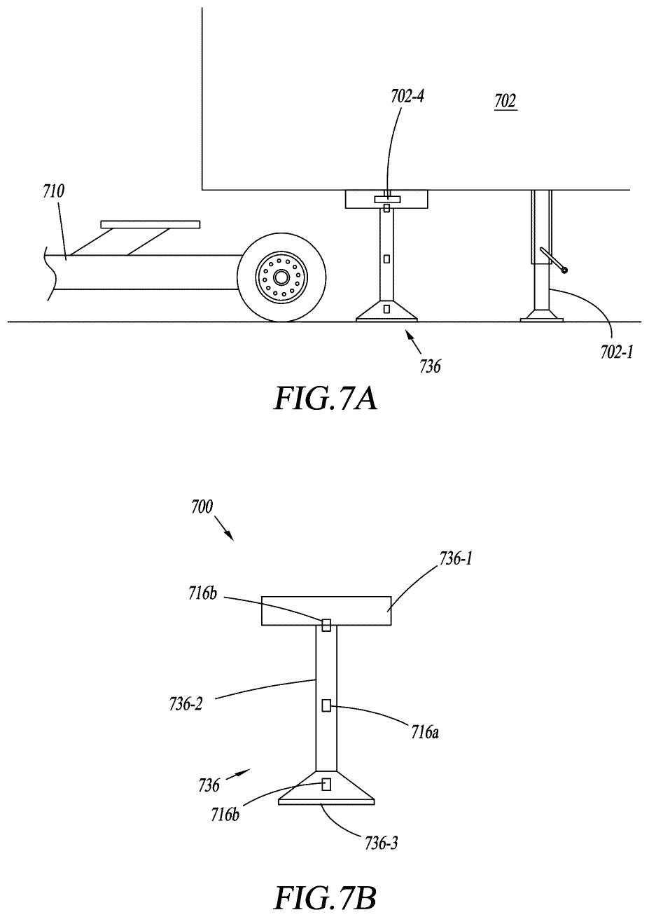

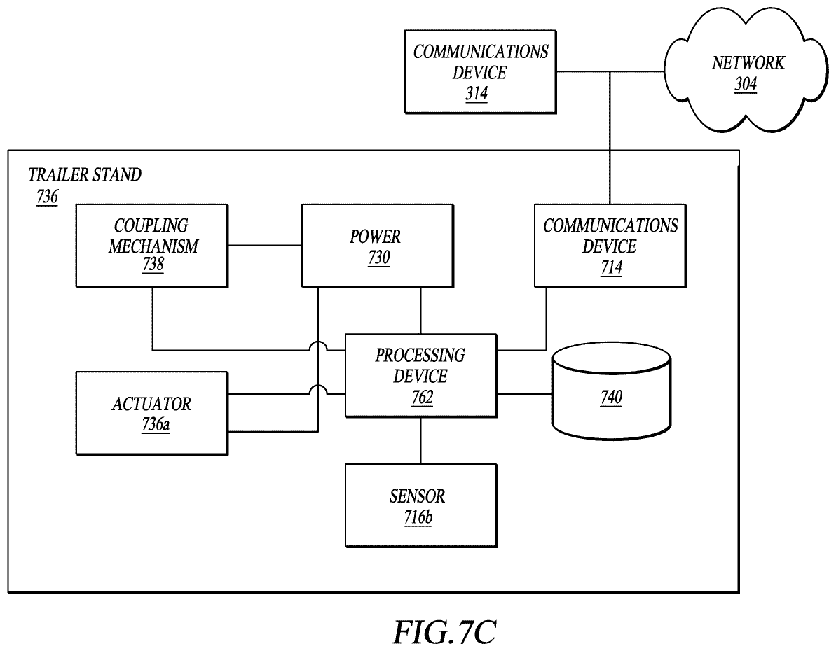

Referring now to FIG. 7A and FIG. 7B, diagrams of a system 700 according to some embodiments are shown. The system 700 may comprise, for example, a trailer 702 comprising landing gear 702-1 and a kingpin 702-4. In some embodiments, a yard vehicle 710 may be in communication with and/or carry one or more sensors 716a-b coupled to a trailer stand 736. The trailer stand 736 may comprise a head 736-1 coupled to an extendible leg 736-2 that is itself coupled to (or comprises) a foot 736-3. As depicted in FIG. 7A, the trailer stand 736 may be positioned by the yard vehicle 710 and coupled to the trailer 702 (e.g., to the kingpin 702-4 thereof, as depicted). In some embodiments, the one or more sensors 716a-b may comprise at least one vertical, first, or axial strain gauge, piezoelectric sensor or pad 716a that measures strain and/or displacement with respect to the vertical and/or with respect to the axial orientation of the extendible leg 736-2. In the case that the extendible leg 736-2 is extended to contact and/or support the trailer 702, for example, the first strain gauge 716a may measure a first mass, weight, displacement, and/or force exerted by the trailer 702 on the trailer stand 736. In some embodiments, the one or more sensors 716a-b may comprise at least one horizontal, second, or lateral strain gauge 716b that measures strain and/or displacement with respect to the horizontal and/or with respect to the normal of the axial orientation of the extendible leg 736-2. In the case that the extendible leg 736-2 is extended to contact and/or support the trailer 702, for example, the second strain gauge(s) 716b may measure a second mass, weight, displacement, and/or force exerted by the trailer 702 on the trailer stand 736. In some embodiments, piezoelectric sensors may be used.

In some embodiments, one or more of the sensors 716a-b may be coupled and/or configured to sense various data elements such as, but not limited to: (i) placement/location of the trailer stand 736; (ii) whether the trailer stand 736 (and/or the head 736-1 thereof) is in contact with the trailer 702 (and/or the kingpin 702-4 thereof); and/or (iii) whether the trailer stand 736 is coupled/mated to the yard vehicle 710 (or not). In some embodiments, one or more of the sensors 716a-b may be disposed on the yard vehicle 710, e.g., as opposed to the trailer stand 736. According to some embodiments, each of the trailer stand 736 and the yard vehicle 710 may comprise one or more of the sensors 716a-b. In some embodiments, one or more of the trailer stand 736 and the yard vehicle 710 may comprise a sensor 716a-b that is utilized/leveraged by the coupling of the trailer stand 736 and the yard vehicle 710 (e.g., utilizing mirrors, tubes, electrical connections, fiber optic pathways, etc.).

With respect to the placement/location of the trailer stand 736, there can be significant differences between trailer structures among different trailer manufacturers. Manual trailer stands are normally installed to make use of structural members of the trailer 702 itself. They are usually placed between the beginning of the trailer (nose) and the landing gear 702-1. The closer they are to the nose of the trailer, the better the trailer stands prevent the chances of the trailer upending due to mechanical advantage. Therefore, manual trailer stands are usually placed at a structural member (not shown) underneath the nose of the trailer 702.

In some embodiments of the present invention, the trailer stand 736 may be positioned at the nose of the trailer 702 beneath, for example, a structural support member (cross-beam, etc.) of the trailer 702. The disposition of the trailer stand 736 at the nose may prevent upending of the trailer 702 in the event the forklift and/or cargo within the trailer 702 moves to, or is disposed in, the front of the trailer 702. The detection of the structural member underneath the nose of the trailer 702 can be performed with a variety of sensors including LiDAR, cameras, radars, stereo vision, and ultrasounds (e.g., the sensors 716a-b). More than one trailer stand 736 may be positioned beneath the trailer 702. For example, a first trailer stand 736 may be positioned beneath the bed of the trailer 702 at a location spaced from the nose or front end of the trailer 702 and a second trailer stand 736 may be disposed at or close to the nose of the trailer 702.

In addition, the positioning of the trailer stand 736 at the nose of the trailer 702 will minimize any potential of the trailer 702 from “rocking” or shifting which may occur with conventional trailer stands. For example, conventional trailers having a particular wheelbase may be parked in specific areas of the yard, and may create indentations, ruts (particularly tire impressions), potholes, etc. in the ground surface within this area. This becomes problematic particularly in the event in which a trailer having a different wheelbase is parked in the indented or rotted area created by the prior trailers. This can cause the newly parked trailer's forward/back position to be precarious, such that any movement/jostling may cause the wheels perched at the edge of a rut to enter the rut, causing the trailer to shift forward or back (as opposed to upending or collapsing). The provision of the trailer stand 736 at the nose of the trailer 702 may minimize this shifting movement. Attachment of the trailer stand 736 to the kingpin of the trailer could also prevent forward/back shifting of the trailer in similar situations.

In some embodiments, the sensors 716a-b capture data that differentiates between the structural member of the trailer 702 itself and a refrigeration unit (not shown) that is attached to the nose of the trailer 702. According to some embodiments, the sensors 716a-b may be utilized not only to detect the structural member, but to also (or alternatively) measure the distance between the ground and the trailer 702. This measurement may be utilized, for example, to automatically and dynamically set the height of the extendible leg 736-2.

According to some embodiments, the trailer stand 736 may be adjusted preferably to provide no gap with the trailer 702. If there is gap between the trailer stand 736 and the trailer 702 in the case of a landing gear 702-1 collapse or upending, the trailer 702 could have sufficient time and distance to accelerate possibly creating forces that break the trailer stand 736 or force the structural member in the trailer 702 to fail. Therefore, accurately elevating the trailer stand 736 may comprise a valuable function. In order to do so, the sensors 716a-b (e.g., a LiDAR, radar, camera, or ultrasonic sensor) can be used to measure that distance. In some embodiments, the sensors 716a-b comprise a strain gauge that is utilized to measure the force applied between the ground and the trailer 702 as a trailer stand 736 expands. A controller (not shown) can use the sensors 716a-b and or the distance measurements to adjust the height of the trailer stand 736 to the preferred setting depending on the load and trailer type.

In some embodiments, the sensors 716a-b (e.g., LADAR, radar, camera, or ultrasonic sensors) can be used to measure the distance and/or to measure the contact between the trailer stand 736 and the back of the yard vehicle 710. In some embodiments, QR codes, April tags, or fiducials (not shown) may be built into the trailer stand 736 to aid the driver (e.g., in the case that the yard vehicle 710 is manually operated) with the mating process.

In some embodiments, the controller can aid a human driver in mating with the trailer stand 736 or it can provide guidance to an autonomous yard vehicle 710. The general tasks of the controller may be, in some embodiments, as follows
(i) the controller can interface with logistics software to determine if a trailer stand 736 is necessary for a particular trailer 702. It is likely that in some yards, trailer stands 736 might only be required for certain type of trailers 702, for certain loads (not shown), or for certain equipment (not shown) being utilized for loading and unloading;
(i) the controller may determine the desired trailer stand placement and possibly provide indications to the driver on the distance necessary to move the yard vehicle 710 to provide correct placement of the trailer stand 736. This distance computation can be communicated as an actual measurement, or it can be an auditory or visual feedback provided to the operator;
(ii) the controller can initiate and/or perform a maneuver of expanding the trailer stand 736. While this operation is being performed, the controller may indicate to the driver that the yard vehicle 710 is not ready to move. In some embodiments, the controller can stop the yard vehicle 710 from moving by engaging the service or emergency brakes; and/or
(iii) the controller may provide feedback to the operator or autonomy software as to the state of the trailer stand deployment. For example, the controller can provide a status of different states: (a) attached to the yard vehicle 710/not attached to the yard vehicle 710 and/or (b) not deployed, deployed, expanding, or contracting.

With reference to FIG. 7C, in some embodiments, at least some and possibly all of the devices and/or components of the devices of the system may be incorporated into the trailer stand 736 or coupled to their corresponding components in the yard vehicle. For example, the trailer stand 736 may include one or more of the processing devices 712, communication devices 714, one or more sensors 716b, power device 730, an actuator 736a for extending and reducing the height of the trailer stand 736 and components of the coupling mechanism 738 for coupling to the yard vehicle 736. A memory device 740 may also be included. In some embodiments, the trailer stand 736 when released from the vehicle trailer may be remotely controlled through a communication device 314 associated with the yard vehicle and/or the network 304 to control actuation of the actuator 736a, the sensors 716b etc. in the manner described hereinabove.

In some embodiments, the trailer stand 736 may be entirely autonomous and be operated without (or with minimal assistance) from the yard vehicle 710. For example, the trailer stand 736 may be self-propelled and capable of maneuvering itself for positioning beneath the trailer. In some embodiments, the trailer stand 736 may include most (possibly all) of the devices of the yard vehicle described in connection with FIG. 3, including, without limitation and in addition to the devices of FIG. 7C, a propulsion device, a maneuver device, a memory device, one or more sensors, and input device etc. In some embodiments, the trailer stand 736 may be mounted on, or associated with a mobile platform, for example, contain a wheel base (similar to the yard vehicle), to enable self-maneuvering via the guidance and assistance effected by the processing device, sensors, memory device, power device etc. in a manner similar to the movement and operation of the yard truck described in connection with FIG. 3. The trailer stand 736 may utilize its actuator 336 to extend and engage the trailer in supporting relation therewith and reduce in length to release the trailer. In some embodiments, the trailer stand 736 may be mounted to its wheel base during actuation of the actuator 336 and support of the trailer. In some embodiments, the trailer stand 736 may release itself from the wheel base prior to use of the actuator 336a.

### III. Yard Vehicle ADAS Apparatus & Articles of Manufacture

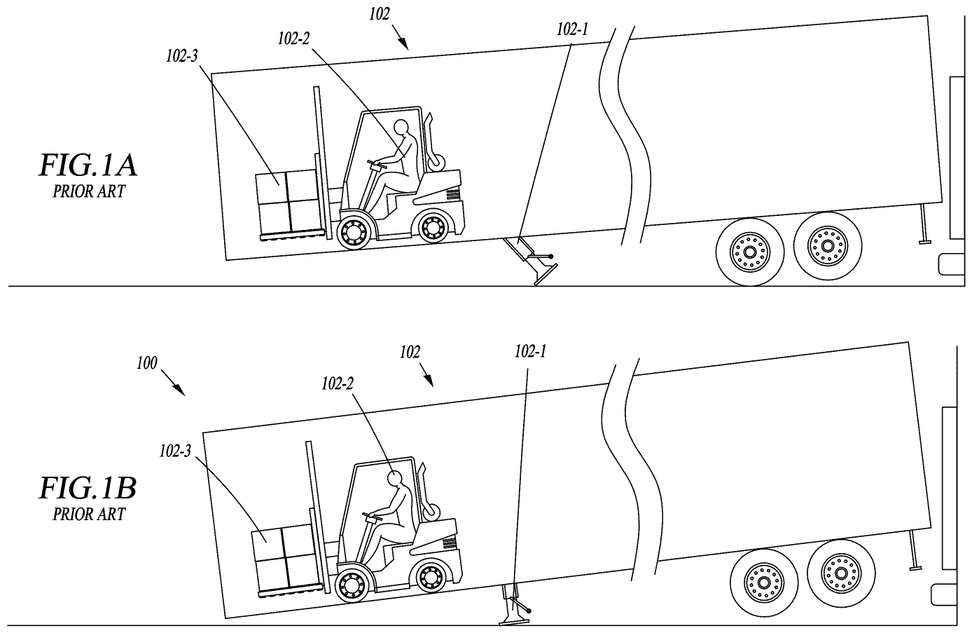

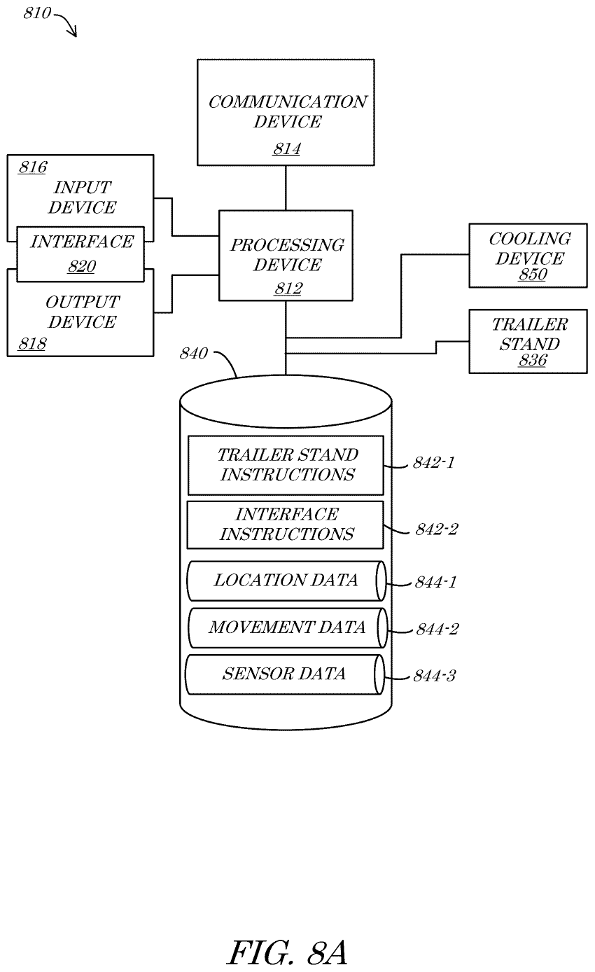

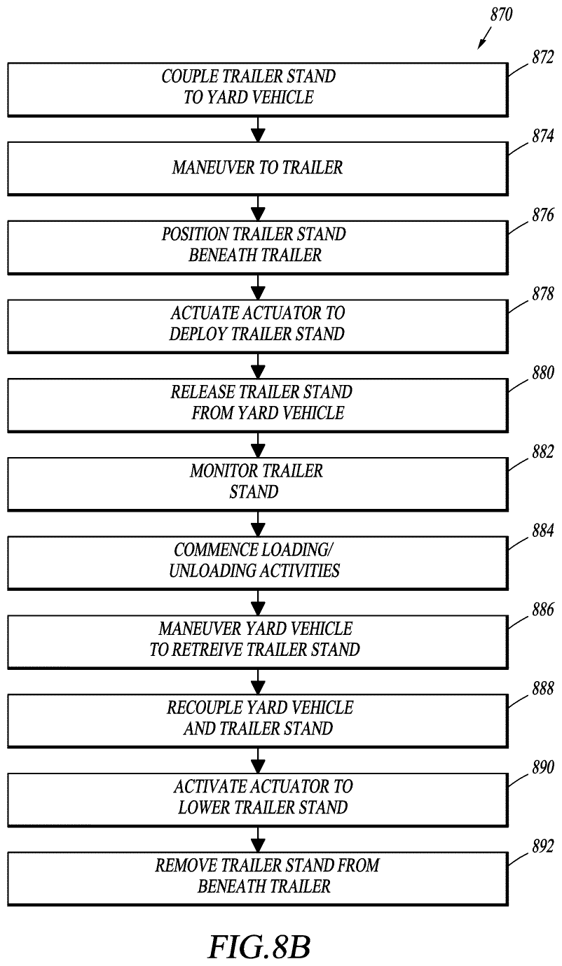

Turning to FIG. 8A, a block diagram of an apparatus 810 according to some embodiments is shown. In some embodiments, the apparatus 810 may be similar in configuration and/or functionality to one or more of the yard vehicle 110 and/or remote server 130 of FIG. 1 herein. The apparatus 810 may, for example, execute, process, facilitate, and/or otherwise be associated with a method in which autonomous trailer stands are deployed, adjusted, and/or retrieved. In some embodiments, the apparatus 810 may comprise a processing device 812, a communication device 814, an input device 816, an output device 818, an interface 820, a trailer stand 836, a memory device 840 (storing various programs and/or instructions 842 and data 844), and/or a cooling device 850. According to some embodiments, any or all of the components 812, 814, 816, 818, 820, 836, 840, 842, 844, 850 of the apparatus 810 may be similar in configuration and/or functionality to any similarly named and/or numbered components described herein. Fewer or more components 812, 814, 816, 818, 820, 836, 840, 842, 844, 850 and/or various configurations of the components 812, 814, 816, 818, 820, 836, 840, 842, 844, 850 may be included in the apparatus 810 without deviating from the scope of embodiments described herein.

According to some embodiments, the processor 812 may be or include any type, quantity, and/or configuration of processor that is or becomes known. The processor 812 may comprise, for example, an Intel® IXP 2800 network processor or an Intel® XEON™ Processor coupled with an Intel® E7301 chipset. In some embodiments, the processor 812 may comprise multiple inter-connected processors, microprocessors, and/or micro-engines. According to some embodiments, the processor 812 (and/or the apparatus 810 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 810 comprises a server, such as a blade server, necessary power may be supplied via a standard AC outlet, power strip, surge protector, and/or Uninterruptible Power Supply (UPS) device.

In some embodiments, the communication device 814 may comprise any type or configuration of communication device that is or becomes known or practicable. The communication device 814 may, for example, comprise a Network Interface Card (NIC), a telephonic device, a cellular network device, a router, a hub, a modem, and/or a communications port or cable. In some embodiments, the communication device 814 may be coupled to receive location data, e.g., from a sensor device (not separately shown in FIG. 8A). The communication device 814 may, for example, comprise a BLE and/or RF receiver device and/or a camera or other imaging device that acquires data descriptive of a location and/or a transmitter device that provides the data to a remote server and/or server or communications layer (not separately shown in FIG. 8A). According to some embodiments, the communication device 814 may also or alternatively be coupled to the processor 812. In some embodiments, the communication device 814 may comprise an IR, RF, Bluetooth™, Near-Field Communication (NFC), and/or Wi-Fi® network device coupled to facilitate communications between the processor 812 and another device (such as a remote user device, e.g., a tele-operations station, not separately shown in FIG. 8A). In some embodiments, the communication device 814 may include a Global Navigation Satellite System (GNNS) and/or Global Positioning System (GPS) receiver/antenna/transmitter.

In some embodiments, the input device 816 and/or the output device 818 are communicatively coupled to the processor 812 (e.g., via wired and/or wireless connections and/or pathways) and they may generally comprise any types or configurations of input and output components and/or devices that are or become known, respectively. The input device 816 may comprise, for example, a knob, wheel, lever, shifter, pedal, button, switch, and/or other object that permits an operator (e.g., local or remote operator personnel) to control a speed and/or direction of the apparatus 810. In some embodiments, the input device 816 may comprise a sensor, such as a camera, sound, light, radar, RF, and/or proximity sensor, configured to measure and/or record values via signals to the apparatus 810 and/or the processor 812. The output device 818 may, according to some embodiments, comprise a display screen and/or other practicable output component and/or device such as a sounder, light, vibration device, etc. The output device 818 may, for example, provide an interface (such as the interface 820) via which trailer stand location, deployment, and/or status data may be provided to a vehicle operator (e.g., via a mobile device application). According to some embodiments, the input device 816 and/or the output device 818 may comprise and/or be embodied in a single device, such as a touch-screen monitor.

The memory device 840 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 840 may, according to some embodiments, store one or more of trailer stand instructions 842-1 and/or interface instructions 842-2, location data 844-1, movement data 844-2, and/or sensor data 844-3. In some embodiments, the trailer stand instructions 842-1 and/or interface instructions 842-2, location data 844-1, movement data 844-2, and/or sensor data 844-3 may be utilized by the processor 812 to provide output information via the output device 818 and/or the communication device 814.

According to some embodiments, the trailer stand instructions 842-1 may be operable to cause the processor 812 to process the location data 844-1, movement data 844-2, and/or sensor data 844-3 in accordance with embodiments as described herein. Location data 844-1, movement data 844-2, and/or sensor data 844-3 received via the input device 816 and/or the communication device 814 may, for example, be analyzed, sorted, filtered, decoded, decompressed, ranked, scored, plotted, and/or otherwise processed by the processor 812 in accordance with the trailer stand instructions 842-1. In some embodiments, location data 844-1, movement data 844-2, and/or sensor data 844-3 may be fed by the processor 812 through one or more mathematical and/or statistical formulas and/or models in accordance with the trailer stand instructions 842-1 to automatically deploy, activate, de-couple, place, couple, retrieve, and/or adjust a trailer stand, as described herein.

In some embodiments, the interface instructions 842-2 may be operable to cause the processor 812 to process the location data 844-1, movement data 844-2, and/or sensor data 844-3 in accordance with embodiments as described herein. Location data 844-1, movement data 844-2, and/or sensor data 844-3 received via the input device 816 and/or the communication device 814 may, for example, be analyzed, sorted, filtered, decoded, decompressed, ranked, scored, plotted, and/or otherwise processed by the processor 812 in accordance with the interface instructions 842-2. In some embodiments, location data 844-1, movement data 844-2, and/or sensor data 844-3 may be fed by the processor 812 through one or more mathematical and/or statistical formulas and/or models in accordance with the interface instructions 842-2 to provide an interface that shows trailer stand position and/or status data, as described herein.

In some embodiments, the apparatus 810 may comprise the trailer stand 836. The trailer stand 836 may comprise, for example, an automatically actuatable, extendible leg or body that can be dynamically adjusted to engage between a trailer and the ground and/or to dynamically disengage with a trailer for removal of the trailer stand 836.

According to some embodiments, the apparatus 810 may comprise the cooling device 850. According to some embodiments, the cooling device 850 may be coupled (physically, thermally, and/or electrically) to the processor 812 and/or to the memory device 840. The cooling device 850 may, for example, comprise a fan, heat sink, heat pipe, radiator, cold plate, and/or other cooling component or device or combinations thereof, configured to remove heat from portions or components of the apparatus 810.

Any or all of the exemplary instructions and data types described herein and other practicable types of data may be stored in any number, type, and/or configuration of memory devices that is or becomes known. The memory device 840 may, for example, comprise one or more data tables or files, databases, table spaces, registers, and/or other storage structures. In some embodiments, multiple databases and/or storage structures (and/or multiple memory devices 840) may be utilized to store information associated with the apparatus 810. According to some embodiments, the memory device 840 may be incorporated into and/or otherwise coupled to the apparatus 810 (e.g., as shown) or may simply be accessible to the apparatus 810 (e.g., externally located and/or situated).

FIG. 8B is a flow chart illustrating an exemplary methodology of use of the system 870 in accordance with some embodiments of the present disclosure. In accordance with some embodiments, the yard vehicle 110 is coupled to the trailer stand 836 via any of the coupling arrangements described hereinabove. (STEP 872). The yard vehicle 110 with coupled trailer stand 836 is maneuvered to the location of the trailer. (STEP 874) The maneuvering may be facilitated via the processing device 812, for example, utilizing the location data 844-1, movement data 844-2 and sensor data 844-3. In some embodiments, the path of travel is stored in the memory coupled to the processor. In STEP 876, the trailer stand 836 is positioned beneath the trailer at the desired location in accordance with the data and information processed by the processing device 812 and/or stored with the memory 840. In embodiments, the trailer stand 836 may be positioned at the nose of the trailer or spaced from the nose. The extension member or actuator associated with the trailer stand 836 is activated to extend or deploy the trailer stand 836 in supporting relation with the trailer. (STEP 878). The trailer stand 836 is released from the yard vehicle 110 by deactivating or decoupling the associated coupling mechanisms. (STEP 880). The condition of the trailer stand 836 is monitored with the one or more sensors and the collected sensor data 844-3. (STEP 882). For example, and without limitation, any undue stress or strain both lateral and vertical detected by any of the strain sensors along with orientation of the trailer stand 836 relative to the trailer 110 and the ground support will be continually monitored. If needed, corrective actions are taken if necessary, including resetting, removal and/or replacement of the trailer stand 836. Loading and/or unloading activities of the trailer may be commenced. (STEP 884). Upon completion of these activities, the yard vehicle 836 is returned to the trailer location via the assistance of the processing device 812, location data 844-1, movement data 844-2 and sensor data 844-3 possibly in accordance with the interface instructions 842-1. (STEP 886). The yard vehicle 110 is recoupled to the trailer stand 836 via cooperative engagement of the coupling mechanism. (STEP 888). The actuator associated with the trailer stand 836 or the yard vehicle 810 is activated to reduce the length of the trailer stand 836 to assume, e.g., a non-deployed condition. (STEP 890). The yard trailer 110 and coupled trailer stand 836 are removed from the trailer area. (STEP 892).

In some embodiments, a system for automatically deploying and collecting trailer stands comprises:
a) a vehicle with an attachment to carry a trailer stand;
b) an expandable trailer stand with an attachment that mates with the vehicle attachment;
c) one or more sensors that detect trailer stand positioning on the trailer, the length or force exerted by the trailer stand on the trailer and/or the distance between the trailer stand and the vehicle; and.
d) a controller that reads the sensor(s) measurements and provides feedback to the human or autonomous operator on the status of the deployment of the trailer stands.

In some embodiments, the vehicle may be a hostler or yard truck or forklift. The attachment for the trailer stand may be on the back of the vehicle. The attachment on the vehicle and trailer stand(s) may use electromagnet, hooks, or mechanical advantage to center the trailer stand(s) to the assigned attachment at the rear of the vehicle. The trailer stand may attach to the kingpin on the trailer or a structural member between the landing gear and the nose of the trailer.

In some embodiments, the system may further comprise a sensor that can detect the difference between a structural element at the bottom of the trailer and other features like a refrigeration unit. The controller may provide feedback to the human operator related to the distance between the vehicle and the trailer stand, between the vehicle and desired landing spot, the pressure between the ground and the trailers, the status of the mating contact between the vehicle and the trailer stand, and/or establish an API with the autonomous navigation system to provide the same information.

In some embodiments, the system may be coupled to, or include, logic configured to inform the human operator or autonomous system which trailer stands are ready to pick up or drop off.

In some embodiments, the trailer stand may have fiducials that aid maneuvering for the automatic retrieval process. The fiducials on the trailer stand may be used to provide feedback to the human operator or autonomous system on the location of the trailer and/or kingpin. In addition, or alternatively, a fiducial may be disposed on the bottom or side of the trailer that indicates to the controller the placement of the trailer stand.

In some embodiments, a second controller remains with the trailer stand and provides remote measurements of the strains and forces applied by the trailer to the trailer stand. These forces might be an indication that the trailer is about to collapse, or the landing gear has failed.

In some embodiments, the trailer stand maintains the height of the attachment to the vehicle at a constant height to simplify vehicle attachment. The trailer stand may include a hook mechanism which raises and lowers as it expands to allow for hooking on a bar on the back of the vehicle.

In some embodiments, an application programming interface (API) is established between the controller and the autonomous navigation system. This API generates messages that determine the distance to the trailer stand, status of the trailer stand, and possibly instructions to enable engagement and disengagement of a service or an emergency brake of the vehicle.

In some embodiments, a trailer storage location may be identified where the trailer stands may be retrieved or dropped without being extended.

In some embodiments, power for extending and/or deploying the trailer stand is provided by the vehicle or on an onboard battery. A battery may be located on the trailer stand for providing power, and may be recharged by the vehicle while mated.

In some embodiments, the system further comprises additional or secondary sensors on the trailer stand that could be measuring the location of humans or other vehicles surrounding the trailer stand.

In some embodiments, the trailer stand may be used to lift the trailer, replacing the need of having a hydraulic lift on the vehicle. The extension mechanism on the trailer stand may be comprised of a lead screw, worm gear, ratcheting system, or hydraulic actuator. The extension mechanism may prevent contracting if it senses that the landing gear is failing. In this arrangement, the controller will recall the location which the landing gear was supporting the trailer before engaging the trailer stand.

In some embodiments, the controller will prevent the attachment mechanism to engage or prevent movement of the vehicle until the strain gauge shows that forces are no longer applied by the trailer. A measurement before and after load of the strained amounts and the strained distances on the trailer stand are used to measure the deformation of the trailer as the load changes. This deformation measurement can be used as health monitoring of the structural integrity of the trailer and the landing gear.

In some embodiments, vertical and side loads are measured by the trailer stand to provide feedback on the forklift operator maneuvers. Excessive side loads can be indicatory of abusive forklift operator practices. Strong load changes on the vertical strain gauge can be indicatory of cargo collapse or landing gear collapse. The controller may have interfaces to provide this information to the yard vehicle operator or to the warehouse.

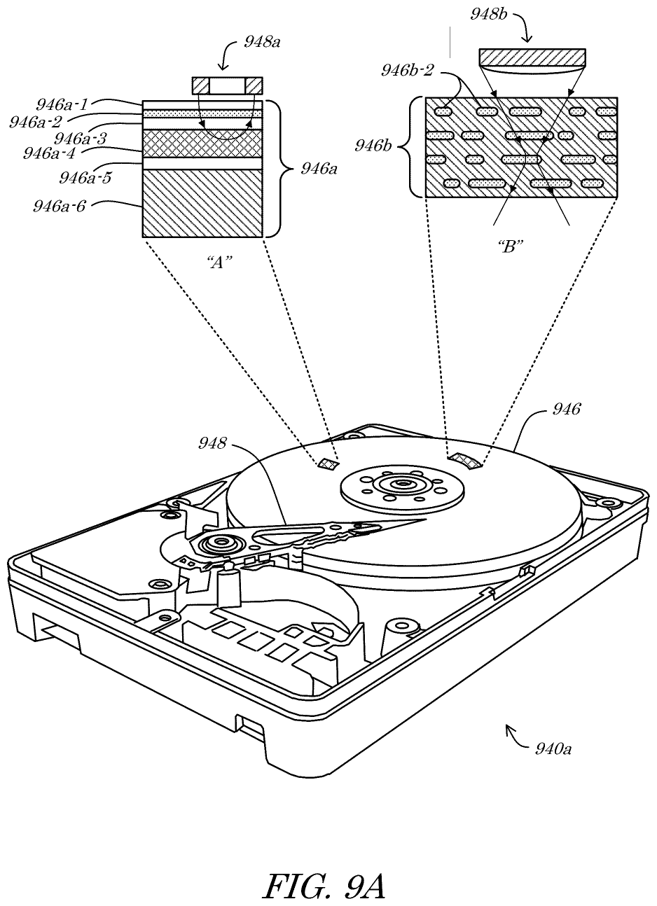

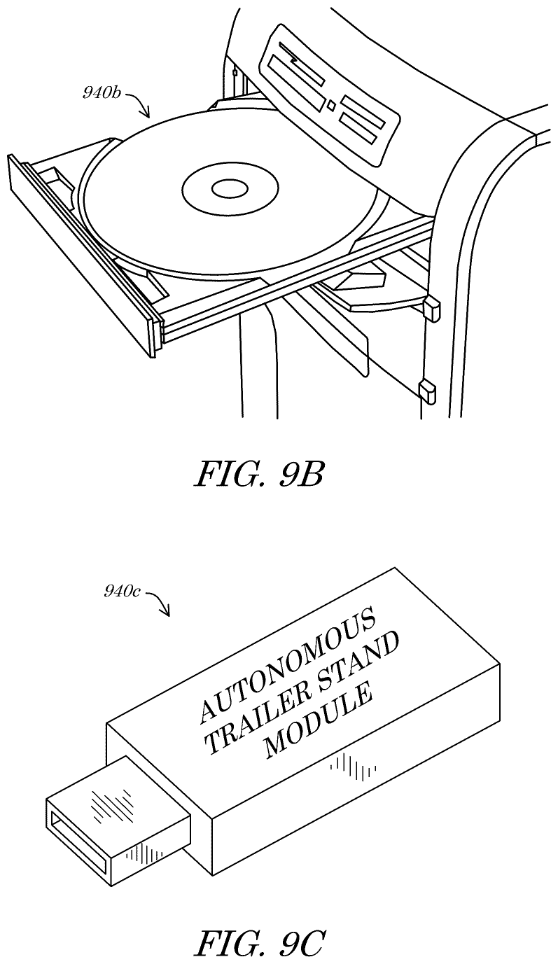

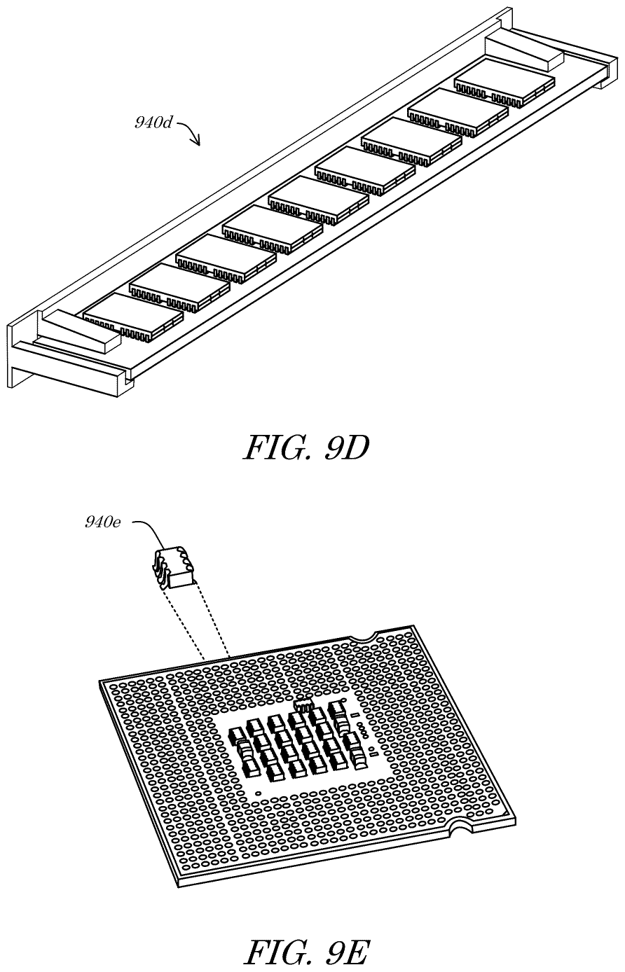

Referring to FIG. 9A, FIG. 9B, FIG. 9C, FIG. 9D, and FIG. 9E, perspective diagrams of exemplary data storage devices 940a-e according to some embodiments are shown. The data storage devices 940a-e may, for example, be utilized to store instructions and/or data such as the trailer stand instructions 842-1 and/or interface instructions 842-2, location data 844-1, movement data 844-2, and/or sensor data 844-3, each of which is presented in reference to FIG. 8 herein. In some embodiments, instructions stored on the data storage devices 340a-e may, when executed by a processor, cause the implementation of and/or facilitate a method in accordance with embodiments herein.

According to some embodiments, the first data storage device 940a may comprise one or more various types of internal and/or external hard drives. The first data storage device 940a may, for example, comprise a data storage medium 946 that is read, interrogated, and/or otherwise communicatively coupled to and/or via a disk reading device 948. In some embodiments, the first data storage device 940a and/or the data storage medium 946 may be configured to store information utilizing one or more magnetic, inductive, and/or optical means (e.g., magnetic, inductive, and/or optical-encoding). The data storage medium 946, depicted as a first data storage medium 946a for example (e.g., breakout cross-section “A”), may comprise one or more of a polymer layer 946a-1, a magnetic data storage layer 946a-2, a non-magnetic layer 946a-9, a magnetic base layer 946a-4, a contact layer 946a-5, and/or a substrate layer 946a-6. According to some embodiments, a magnetic read head 948a may be coupled and/or disposed to read data from the magnetic data storage layer 946a-2.

In some embodiments, the data storage medium 946, depicted as a second data storage medium 946b for example (e.g., breakout cross-section “B”), may comprise a plurality of data points 946b-2 disposed with the second data storage medium 946b. The data points 946b-2 may, in some embodiments, be read and/or otherwise interfaced with via a laser-enabled read head 948b disposed and/or coupled to direct a laser beam through the second data storage medium 946b.

In some embodiments, the second data storage device 940b may comprise a CD, CD-ROM, DVD, Blu-Ray™ Disc, and/or other type of optically-encoded disk and/or other storage medium that is or becomes know or practicable. In some embodiments, the third data storage device 940c may comprise a USB keyfob, dongle, and/or other type of flash memory data storage device that is or becomes know or practicable. In some embodiments, the fourth data storage device 940d may comprise RAM of any type, quantity, and/or configuration that is or becomes practicable and/or desirable. In some embodiments, the fourth data storage device 940d may comprise an off-chip cache such as a Level 2 (L2) cache memory device. According to some embodiments, the fifth data storage device 940e may comprise an on-chip memory device such as a Level 1 (L1) cache memory device.

The data storage devices 940a-e depicted in FIG. 9A, FIG. 9B, FIG. 9C, FIG. 9D, and FIG. 9E are representative of a class and/or subset of computer-readable media that are defined herein as “computer-readable memory” (e.g., non-transitory memory devices as opposed to transmission devices or media). The data storage devices 940a-e may generally store program instructions, algorithms, software engines, code, and/or modules that, when executed by a processing device cause a particular machine to function in accordance with one or more embodiments described herein.

### IV. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

The indefinite articles “a” and “an,” as used herein in the specification and in the claims, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “program” or “computer program” may refer to one or more algorithms formatted for execution by a computer. The term “module” or “software module” refers to any number of algorithms and/or programs that are written to achieve a particular output and/or output goal-e.g., a ‘login credentialing’ module (or program) may provide functionality for permitting a user to login to a computer software and/or hardware resource and/or a ‘shipping’ module (or program) may be programmed to electronically initiate a shipment of an object via a known and/or available shipping company and/or service (e.g., FedEX®). The terms “engine” or “software engine” refer to any combination of software modules and/or algorithms that operate upon one or more inputs to define one or more outputs in an ongoing, cyclical, repetitive, and/or loop fashion. Data transformation scripts and/or algorithms that query data from a data source, transform the data, and load the transformed data into a target data repository may be termed ‘data transformation engines’, for example, as they repetitively operate in an iterative manner upon each row of data to produce the desired results.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

1. A system, comprising:
a vehicle configured to traverse an area;
a trailer stand operatively coupled to the vehicle, the trailer stand configured for positioning relative to a trailer; and
one or more controllers for controlling operation of at least one of the vehicle and the trailer stand.

2. The system according to claim 1, wherein the trailer stand is positionable beneath the trailer, and is configured to transition between a first condition having a first length and a second condition having a second length greater than the first length.

3. The system according to claim 2, including an actuator in communication with the controller for selectively transitioning the trailer stand between the first condition and the second condition.

4. The system according to claim 1, wherein the trailer stand is releasably coupled to the vehicle.

5. The system according to claim 4, including a coupling mechanism for releasably coupling the trailer stand to the vehicle, the coupling mechanism including at least one of a mechanical coupling, an electrical coupling, an electro-mechanical coupling, a magnetic coupling or an electromagnetic coupling, or combinations thereof.

6. The system according to claim 1, including one or more sensors configured to detect one or more conditions of the trailer stand, and to transmit one or more signals to the controller representative of the one or more conditions.

7. The system according to claim 6, wherein the one or more conditions include at least one of:
positional relationship of trailer stand relative to the trailer;
a force exerted by the trailer on the trailer stand;
a distance between the trailer stand and the vehicle;
presence of the trailer stand; and
global positional location of the trailer stand.

8. The system according to claim 6, wherein the one or more controllers is located on the trailer stand.

9. The system according to claim 1, including one or more strain sensors disposed on the trailer stand.

10. The system according to claim 9, wherein the one or more strain sensors includes at least one of a lateral strain sensor or a vertical strain sensor.

11. The system according to claim 1, wherein the controller is configured to maneuver the vehicle based at least in part on positional data associated with the vehicle truck and the trailer stand.

12. The system according to claim 1, including an output coupled to the controller to provide feedback related to at least one of the trailer stand and the vehicle.

13. The system according to claim 1, including one or more secondary sensors to detect an object within the environment.

14. The system according to claim 1 wherein the vehicle is one of a hostler, yard truck and forklift.

15. A system, comprising:
a yard vehicle configured to traverse an area;
a trailer stand releasably coupled to the yard vehicle;
an actuator coupled to the trailer stand to cause transition of the trailer stand between a first transport condition to enable maneuvering of the trailer stand by the yard vehicle about the area and positioning beneath one end of a trailer, and a second deployed condition where the trailer stand supports the one end of the trailer;
a controller configured to control the actuator; and
one or more sensors to detect a condition of the trailer stand relative to at least one of the yard vehicle and the trailer.

16. The system according to claim 15, wherein the controller is configured to control traversing movement of the yard vehicle about the area.

17. The system according to claim 16, including one or more secondary sensors coupled to at least one of the yard vehicle and the trailer stand, the one or more secondary sensors configured to provide one or more signals representative of at least one of a position of the yard vehicle in the area or detection of an object in the area.

18. The system according to claim 15, wherein the one or more sensors are configured to detect an orientation of the trailer stand.

19. The system according to claim 15, wherein the controller is configured to release the trailer stand from the yard vehicle.

20. A system, comprising:
a self-propelled trailer stand configured for movement about a yard;
an actuator coupled to the trailer stand to cause transition of the trailer stand between a first transport condition to enable positioning beneath one end of a trailer, and a second deployed condition where the trailer stand supports the one end of the trailer;
a controller configured to control movement of the trailer stand about the yard and actuation of the actuator; and
one or more sensors to detect at least one of an object in the yard, location of the trailer stand or a condition of the trailer stand relative to the trailer.

21. (canceled)
